(19) United States
(12) Patent Application Publication
(10) Pub. No.: US 2023/0217279 A1
(43) Pub. Date: Jul. 6, 2023

(54) SMART INTERFACE SELECTION

(71) Applicant: APPLE INC., CUPERTINO, CA (US)

(72) Inventors: Henri S. Berger, Los Altos, CA (US); Gencer Cili, San Jose, CA (US); Geoffrey R. Hall, San Jose, CA (US); Franco Travostino, San Jose, CA (US); Muthukumaran Dhanapal, Sunnyvale, CA (US); Sunny R. Dubey, San Jose, CA (US); Pradeep S. Sharma, Cupertino, CA (US); Raghuveer Mallikarjunan, Sunnyvale, CA (US); Ajay Singh, San Jose, CA (US); Ozgur Ekici, Ottawa (CA); Rajesh Ambati, Los Altos Hills, CA (US); Arun G. Mathias, Los Altos, CA (US); Ajoy K. Singh, Milpitas, CA (US); Thomas F. Pauly, Campbell, CA (US)

(73) Assignee: APPLE INC., CUPERTINO, CA (US)

(21) Appl. No.: 17/901,764

(22) Filed: Sep. 1, 2022

Related U.S. Application Data
(60) Provisional application No. 63/239,931, filed on Sep. 1, 2021.

(51) Int. Cl. H04W 24/08

(52) U.S. Cl. CPC H04W 24/08; H04W 92/10

(57) ABSTRACT

A system and method for selecting a network interface for a communication device having at least two radio physical interface, to improve communications by the communication device. A configuration of the communication device is determined, where a first radio physical interface is designated as a primary interface and active, and a second radio physical interface as idle. A networking subsystem of the operating system executes a state machine configured to monitor network conditions and associated performance parameters of the at least two radio physical interfaces, to automatically outrank the second radio physical interface over the first radio physical interface as the primary interface.

### CROSS-REFERENCES TO RELATED APPLICATIONS

This application claims priority to U.S. Provisional Patent Application No. 63/239,931, filed Sep. 1, 2021, entitled “Smart Interface Selection,” which is herein incorporated by reference in its entirety and for all purposes.

### BACKGROUND

In a networking system with multiple networking physical interfaces, there is often a standard primary interface that is automatically given priority over all other interfaces during communications by a communication device. In most cases, this primary interface is programmed as a designated default interface of the networking system. Examples of networking physical interfaces include Wi-Fi, cellular, and Bluetooth® interfaces. However, keeping the standard primary interface as a default often provides a sub-optimal experience to a user by the networking system due to underperforming, non-secure or unstable networking infrastructure.

### SUMMARY

This document describes Smart Interface Selection (SIS) as a system and method by which a networking subsystem of a communication device determines when one networking physical interface should take a higher priority than other communication interfaces to benefit the user's experience with the communication device. As used herein, the term communication device includes mobile telephones, tablet computers, laptop computers and desktop computers, as well as any device having more than one networking physical interface. In some aspects of the present disclosure, a networking subsystem of an operating system of the communication device takes action based on this determination to place the networking interfaces in an order where a non-default interface will take precedence. The primary use cases for SIS are situations where keeping the standard primary interface would provide a sub-optimal experience due to underperforming or insecure networking infrastructure.

A system, method and computer program product of selecting a network interface for a communication device having at least two radio physical interfaces are described. The selecting is configured to improve communications by the communication device. A configuration daemon associated with an operating system of the communication device determines a first radio physical interface as a primary interface and a second radio physical interface as idle, where the primary interface is active. A networking subsystem of the operating system executes a state machine that is configured to monitor network conditions and associated performance parameters of the at least two radio physical interfaces.

The state machine receives input from one or more data-gathering subsystems associated with the operating system, where the input characterizes the network conditions and the associated performance parameters. The state machine, in response to the monitored network conditions and associated performance parameters of the at least two radio physical interfaces, provides an outrank state indication to the configuration daemon, the outrank state indication indicating whether the second radio physical interface should be the primary interface. The configuration daemon then can configure the second radio physical interface as the primary interface and the first radio physical interface as idle.

Implementations of the current subject matter can include, but are not limited to, methods consistent with the descriptions provided herein, as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a smart interface selection system and method, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an interface on a communication device having one or more features consistent with implementations of the current subject matter;

FIG. 2 is a state machine diagram illustrating aspects of a method having one or more features consistent with implementations of the current subject matter;

FIG. 3 is a graph showing download speeds of various interfaces of a communication device;

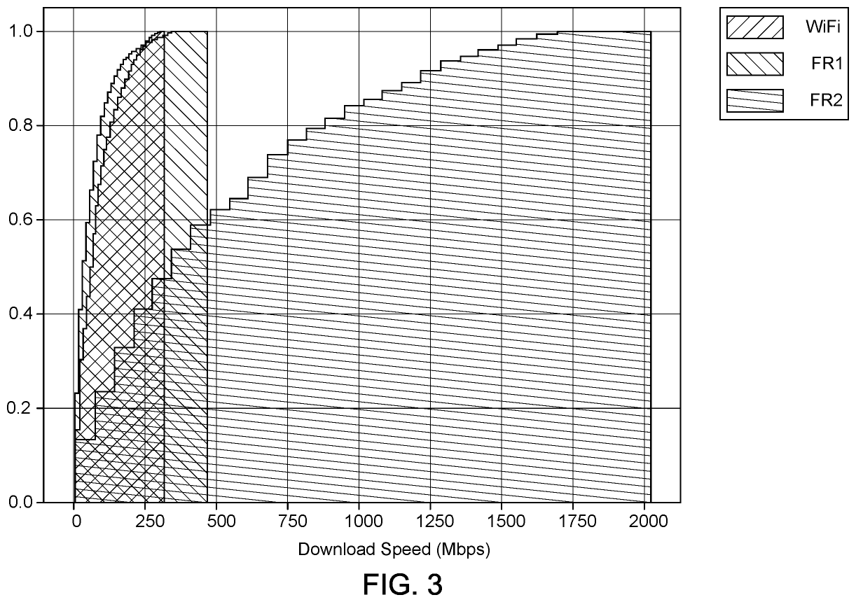

FIG. 4 is a block diagram illustrating aspects of a method having one or more features consistent with implementations of the current subject matter;

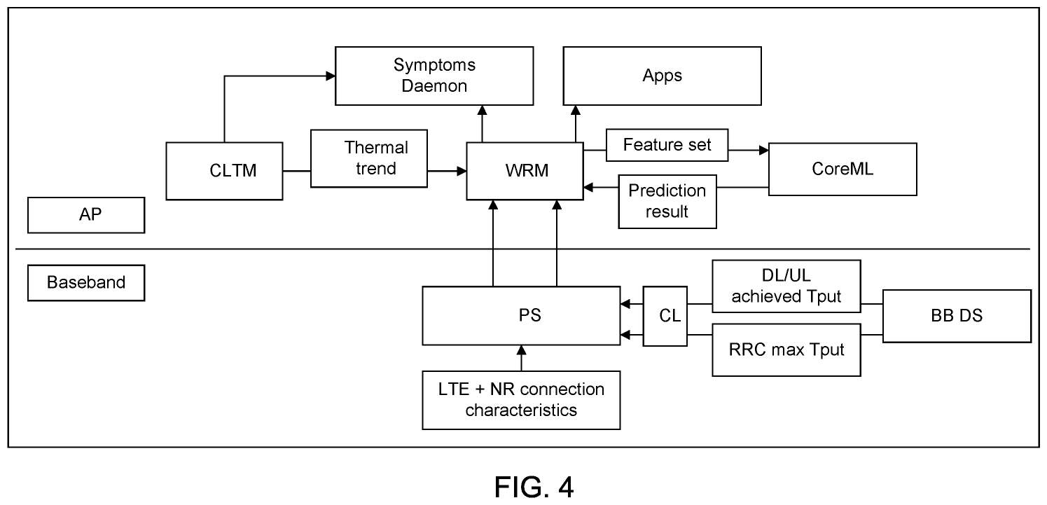

FIG. 5A shows various graphs showing download speeds of various interfaces of a communication device;

FIG. 5B shows various graphs showing download speeds of various interfaces of a communication device;

FIG. 5C shows various graphs showing download speeds of various interfaces of a communication device;

FIG. 6 is a flowchart of a method having one or more features consistent with implementations of the current subject matter; and

FIG. 7 is a flowchart of another method having one or more features consistent with implementations of the current subject matter.

When practical, similar reference numbers denote similar structures, features, or elements.

### DETAILED DESCRIPTION

As discussed herein, Smart Interface Selection (SIS) is a process, preferably configured as software, by which a networking subsystem of a communication device's operating system determines when one networking physical interface should take a higher priority than other interfaces to provide a better networking experience for the user. The networking subsystem can be configured to take action based on this determination, to reorder the networking interfaces where the non-default interface will take precedence.

Among the various use cases for SIS, a first use case entails situations where keeping the standard primary interface would provide a sub-optimal experience due to underperforming or insecure networking infrastructure. A second use case entails a situation where the primary network interface is functioning within good parameters, but switching to the better interface would allow for an even better user experience. For example, this case could be downloading a movie to a communication device over a non-primary interface that would take one-tenth the time of a primary interface.

The subject matter disclosed herein can be applied in a use case-specific selection of a radio interface from multiple physical interfaces (e.g., detecting large media/application downloads, then making the decision to switch to a faster physical interface link, such as cellular). The applications of the present disclosure can include, without limitation: a live query crowd-sourced database to sense frequency range (FR) availability (i.e. FR1 vs. FR2) without performing 5G New Radio (NR) measurements while Wi-Fi is the primary interface; security-aware interface selection to prefer secure NR connections compared to unsecure Wi-Fi access points; monitoring proactive thermal trends (i.e. time series prediction) to avoid selecting a link that will further increase the thermal pressure of the communication device; dynamically evaluating and adjusting cellular vs. Wi-Fi decisions based on a capability of the cellular radio link capabilities (Wi-Fi channel, band, Long Term Evolution (LTE) with NR bandwidth, modulation, multiple-input, multiple-output (MIMO) etc.); comparing co-located Wi-Fi/cellular link latency and/or speed to automatically prefer the link that will provide a better user experience; and using a heuristic randomization factor to outrank Wi-Fi to prevent a “stadium effect” whereby all communication devices in a common environment switch interfaces at the same time.

In some implementations, SIS is a software process implemented on a non-transitory machine-readable medium of the communication device, storing instructions that, when executed by at least one programmable processor, cause the at least one programmable processor to perform the SIS operations. The software takes into account several inputs from the system to make a decision as to when, in this case, to tell the networking subsystem to deprioritize a first interface, such as a Wi-Fi interface, to prefer a second interface, such as a cellular interface.

In some implementations, a state machine called the Cellular Outrank State Machine (COSM) is employed by the networking subsystem to execute the decision making. In a specific example, the decision making can be performed by a system configuration daemon, sometimes referred to as “configd,” that runs behind an operating system, such as macOS developed by Apple, Inc, for example. The COSM monitors networking conditions, and under a specific set of scenarios, will indicate to the configuration daemon that the cellular interface should outrank another interface such as Wi-Fi. In one specific example, the COSM takes inputs from several system sub-components/processes associated with the communication device to make the decision, the inputs being from various subsystems including, but not limited to: 1) a wireless radio coexistence subsystem; 2) a cellular subsystem; 3) a media subsystem; 4) a device-driver subsystem; 5) a device power/thermal subsystem; 6) a network statistics subsystem; 7) a networking services discovery daemon; 8) a configuration daemon; 9) a networking framework; 10) a Wi-Fi subsystem; 11) a device thermal subsystem; and/or other systems or subsystems.

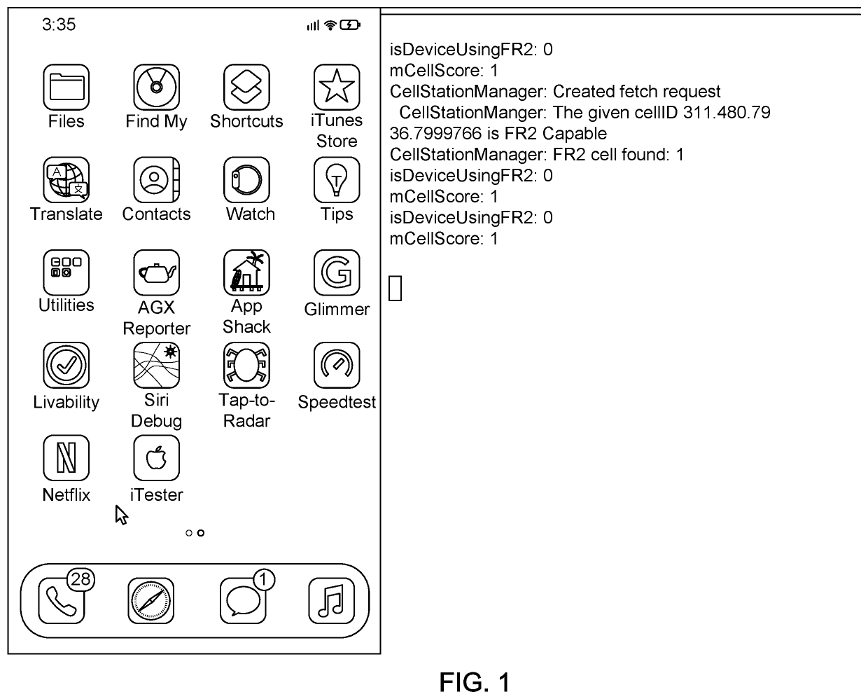

FIG. 1 illustrates a scenario where a communication device detects a frequency range or bands, such as Frequency Range 2 capability (referred to herein as “FR2,” which designates a frequency range above 24.250 GHz for 5G radio communications), while Wi-Fi is designated as primary and cellular is in Radio Resource Control (RRC) IDLE mode. The detection can be made by checking crowdsourced FR2 database and transitions to 5G mmWave for the media download activity. Once the download is completed, the communication device can be returned back to the Wi-Fi interface.

In some implementations, an output from the COSM is configured to handle prioritizing networking interfaces. In one specific example, this output is configured to determine whether the Wi-Fi Link Layer should or should not be used. Further, the COSM includes a feedback mechanism to the wireless radio coexistence subsystem as to the state of the COSM and why a change was made.

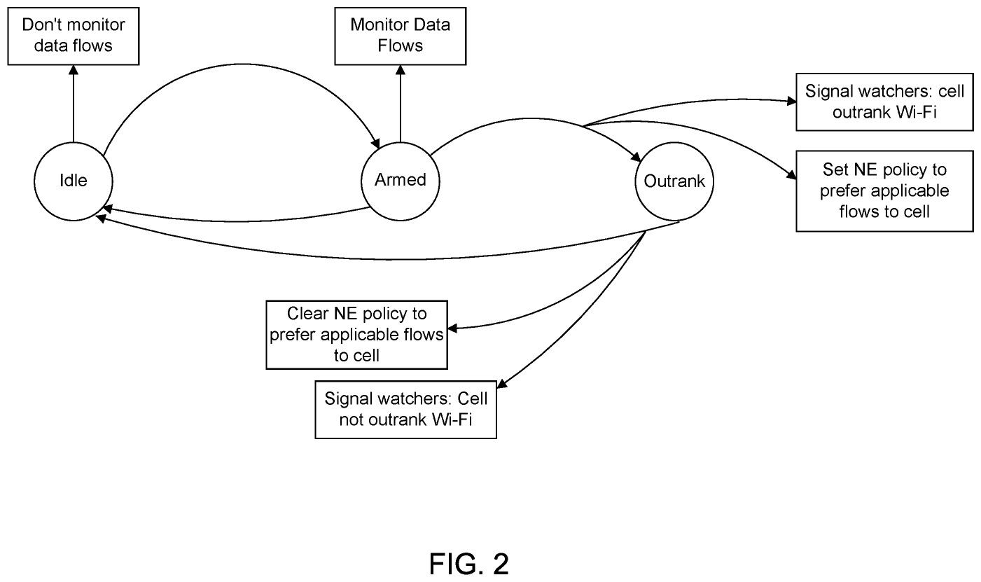

As illustrated in the state machine diagram shown in FIG. 2, the COSM has three states: idle, armed and outrank, described in further detail below.

1) The idle, or “at-rest,” state is where the COSM remains when a set of prerequisites of the operation of the communication device have not been met. In some preferred implementations, the set of prerequisites to exit this state can include: Wi-Fi is the primary interface; the communication device is not in system-wide low-power mode; and the communication device is not in a moderate or higher system thermal state. Other prerequisites include, without limitation: the cellular interface is indicated as inexpensive (primarily on 5G) and not in a user-specified constrained state (Low Data Mode); the Wi-Fi Assist feature is not active; and/or the device is not in a known home or work location or using public Wi-Fi infrastructure. Once all predetermined states are verified, the COSM exits the idle state and proceeds to the armed state.

A database can be utilized to determine device/Wi-Fi/cellular connection information to inform decisions. For example, a commonly used Wi-Fi network association might be considered a disincentive to outranking the Wi-Fi association by Cell. Additionally, the COSM waits for a random delay before it will move to the armed state. This random delay is to prevent a large cohort of devices from all potentially switching from an idle to outrank state at the exact same time. Once all of these idle prerequisites are verified, the COSM exits the idle state and proceeds to the armed state.

2) In the armed state, the COSM starts monitoring networking data flows and starts processing event-driven indications that a cellular connection should outrank the Wi-Fi network is in a user-specified constrained state (i.e., Low Data Mode). There can be user-initiated data flows which meet minimum requirements, and TCP statistics that show that transmissions are failing. There are data stalls, imminent Audio-Visual data stalls, or the like. A Broken Backhaul detection system can be in an active or positive state but not in a confirmed broken state and not idle. Once a combination of these items is observed, the COSM exits the armed state and proceeds to the outrank state.

In some implementations, the armed state provides an indication that the Wi-Fi network is in a user-specified constrained state (i.e., Low Data Mode). These constrained states can include, without limitation: there are connection certificate errors; the Wi-Fi network is unsecured; there are networking failures reported from one of several networking components; there are network traffic flows that would benefit from going over a cellular interface substantially faster than Wi-Fi; there are additional networking friction factors. Once a combination of these items is observed the State Machine exits the armed state and proceeds to the outrank state.

3) The outrank state is when the COSM tells the configuration subsystem to lower the ranking of the Wi-Fi interface, which in turn allows the cellular interface to take primacy. Additionally, the COSM informs the rest of the system of the change.

Once in the outrank state, the COSM continues monitoring the system to decide if the recommendation to outrank should be rescinded. To exit the outrank state, one of several criteria must be met: the cellular data connection becomes inactive; the cellular interface becomes expensive or constrained (i.e., Low Data Mode); the wireless radio coexistence subsystem indicates that the cellular interface quality has decreased; a cellular fallback subsystem has become active; the overall system has gone into a heavy thermal state; the user has put the system into Low Power Mode; the display has been locked or turned off; and/or the Wi-Fi network with which the device is associated has changed and there is no substantial networking traffic in progress.

Finally, when the COSM is in the armed state, beside going to the outrank state, there is also the possibility of going back to the idle state. This would be due to one of the pre-requisites for the idle-to-armed transition no longer being valid, based on one or more of the following states: cellular data has become inactive; the cellular interface has become expensive or constrained (i.e., Low Data Mode); the wireless radio coexistence subsystem indicates that the cellular interface quality has decreased; the cellular fallback subsystem has become active; the display has been locked or turned off; the Wi-Fi network the device is associated with has changed; and/or the device has arrived at a known home or work location or the device is no longer associated to a public hotspot.

One output from this COSM is used to tell the networking control layer (i.e., the system configuration daemon, which handles prioritizing networking interfaces) whether to advise against using the Wi-Fi link layer. A second output of the feedback mechanism to the wireless radio coexistence subsystem can include a state of the COSM, and why a change was made. Each of these states are further described below.

One important consideration is behavior of the communication device in the presence of multiple other devices in a particular environment, such as, for example, a sporting event. The devices should not be allowed to self-synchronize, where many may transfer from Wi-Fi to cellular and then back again en masse. To prevent this, a random timing delay can be introduced. The fallback from being in the outrank state should be immediate, but a reentry to the outrank state can be subject to delay, with that delay being measured from the previous exit point and implemented in any of a number of ways.

### State Transitions

In preferred exemplary implementations, the initial state is always idle if the COSM is admin-enabled. The transition to the armed state requires that basic prerequisites be met before any further escalation can be considered. The armed transition resolves around interface and system states.

In specific exemplary implementations, the requirements for transitioning from the idle to the armed state can be as follows:
1. Wi-Fi is active and the primary interface available from NetworkStateRelay (State)
2. The system is not in Lower Power Mode available from “lowPowerModeEnabled” in the PowerStateRelay (State)

3. The system is not in an elevated thermal state from “thermalPressure” also in the “PowerStateRelay.” Additionally, there should be support for proactive thermal notification. (State)
4. cellular is neither expensive nor constrained (i.e., Low Data Mode) available from “isConstrained” and “isExpensive” from the NWPath's NWInterface. These should be added (if not already present) to the Network State Relay. (State)
5. RNF is idle from the “rnfActivated” property in CellFallbackHandler (State)
6. If Locations of Interest are available and known then the device should not be considered at Home nor at Work. This is available from the LocationStateRelay/NAE. Otherwise, if LOIs are not known, then Wi-Fi is Public. (State)

Once any of these requirements are not satisfied and the COSM is not idle, then the COSM can transition to idle through the armed state if necessary.

In other specific implementations of the present disclosure, requirements for transitioning from the armed to the outrank state are:
1. Wi-Fi is constrained (Low Data Mode)
   A. This factor immediately causes the transition to Outrank. No additional requirements necessary (State)
   B. This is available from the NWPath's NWInterface. These should be added (if not already present) to the Network State Relay.
2. The state of Wi-Fi Captivity is inconclusive
   A. This factor immediately causes the transition to Outrank. No additional requirements necessary (Event)
   B. This is determined as part of Passive Captivity Detection and can be asserted the same time configuration is notified. Note - the configuration daemon notification can be skipped if acting on this input, in order to avoid possible unnecessary user interaction.
3. A single imminent AV Stall from the media subsystem (Event)
   A. This factor immediately causes the transition to Outrank. No additional requirements necessary
4. Foreground activity (or background activity which is user triggered) (Event)
   A. This is determined from [FlowAnalyticsEngine has AnyForegroundApp]
5. Data intensive (Event)
   A. applications (“apps”) with jumboFlows propensity (“jumbo” meaning 50 MB or more on a single flow). Note: the jumbo designation should be restricted to foreground activities only, as background activities do not disclose much.
   B. apps associated with large usage figures
   C. apps that tripped a smart data mode HiTput/HiConf advice when used in the foreground on cellular (this information can be evaluated, just like it is done for jumboFlows)
   D. As examples, apps like Apple Inc.s' AppStore should be data intensive, but other apps such as a Weather App not so data intensive.
6. At least one of the following:
   A. tcpProgressHintsScore>=20 (threshold tunable) (State)
   B. The Data Stall count is above a threshold (Event or State, depending on how accessed)
   C. Wireless Remote Monitoring (WRM) metrics indicate that cellular is in good shape (State). The definitions are below.
   D. DNS Out (State)
   E. Baseband Hotel (BBH) is active or positive (State)
   F. There are at least a couple of weak incentives, such as poor Wi-Fi Security available from Wi-Fi Manager (State), or the device is in motion—Motion State Relay (State)
7. There are disincentives to also consider:
   1. User joins network manually by providing a hidden network SSID available from the Wi-Fi Manager (Event)

In some implementations, the requirements for transitioning from the outrank to the armed state do not match the ingress requirements. Transitioning between idle and outrank should be minimized. Any idle to armed prerequisite that is no longer met should cause the COSM to exit the outrank state.
1. WRM indicates cellular is bad with any confidence
2. Elevated or proactive thermal notification (really covered by idle->armed pre-requisite)
3. Screen is locked or turns off
4. cellular becomes expensive or constrained (really covered by idle->armed pre-requisite)
5. Wi-Fi becomes Primary for some reason outside of the COSM
6. Wi-Fi Association changes (SSID changes only)

In specific implementations, a CellOutrankHandler can mirror the design of a NoBackhaulHandler in operation, and NSPredicates declared at the top of COSM code indicate the transitions from one state to another. These predicates are currently applied to both the Wi-Fi subsystem and cellular state relays which exist in NetworkAnalyticsEngine. Anything not already in the state relay which applies to an interface will need to be added as a KVOable property to the state relay. Upon outrank state entry, symptoms will set kSCNetworkInterfaceAdvisoryLinkLayerIssue viaSCNetworkInterfaceSetAdvisory( ). Upon outrank state exit, a state kSCNetworkInterfaceAdvisoryNone is set via viaSCNetworkInterfaceSetAdvisory( ). At or around the same time, Darwin notifications can be sent, as further explained below.

In preferred exemplary implementations, a communications channel between WRM (and any other process interested in watching the COSM) and symptoms can use “Darwin Notifications” as further described below.

### Symptoms Darwin Notification Details

In an exemplary implementation, Symptoms will post a system-wide notification (known as a “Darwin notification” in some cases) when the COSM changes (sets/clears) the advisory. A single notification can be posted with a 1 or a 0 as an indication to outrank or not, or a bitfield can be posted, i.e., to the entire system, to provide additional information. Any affected process can register for this Darwin Notification. At first WRM will certainly register for this notification.

The “cellular outrank recommendation” value can be provided in the Darwin Notification. The first bit is the indication of outrank or not. The remaining bits are possible reason(s) for having switched recommendations.

A cellular outrank recommendation can be made based on various cellular radio or network characteristics observed by the communication device in real time, cached on the communication device based on previously observed characteristics on the same location/cell ID, or fetched from a database that has crowd-sourced data points. Evaluation of a Wi-Fi vs. cellular decision depends heavily on the cellular RAT the communication device is currently camped on. Typically, 5G FR2 significantly outperforms Wi-Fi in terms of downlink throughputs. For instance, median FR2 DL speed is greater than almost all Wi-Fi download throughput in the US.

In scenarios where FR2 availability is detected on the current serving cell or location, a cellular outrank recommendation can be provided to the system. This recommendation can make the Wi-Fi interface secondary and cellular interface primary in conditions where there is no proactive thermal pressure mitigation notification. If the thermal management entity detects an upward trend in thermal based on time-series data on device and predicts the device to hit abnormal thermal pressure in a short period of time due to baseband radio hotspot located on the device, cellular outrank decision will be suppressed to avoid ping-ponging between Wi-Fi to FR2 and back to Wi-Fi.

For Wi-Fi vs. 5G FR1 decisions, the wireless radio coexistence subsystem can be configured to be listening to RRC/MAC/PHY characteristics observed by the modem, such as: frequency band, RSRP, RSRQ, SNR, UE Rank, download and upload (DL/UL) bandwidth (in MHz, for example), number of spatial MIMO layers configured and scheduled, download and upload modulation, congestion indication, number of component carriers configured/activated during the connection, etc. In 5G SA networks, the modem will be sending NR connection details. In 5G NSA (EN-DC) networks, the modem will be sending information about both LTE and NR legs across all component carriers.

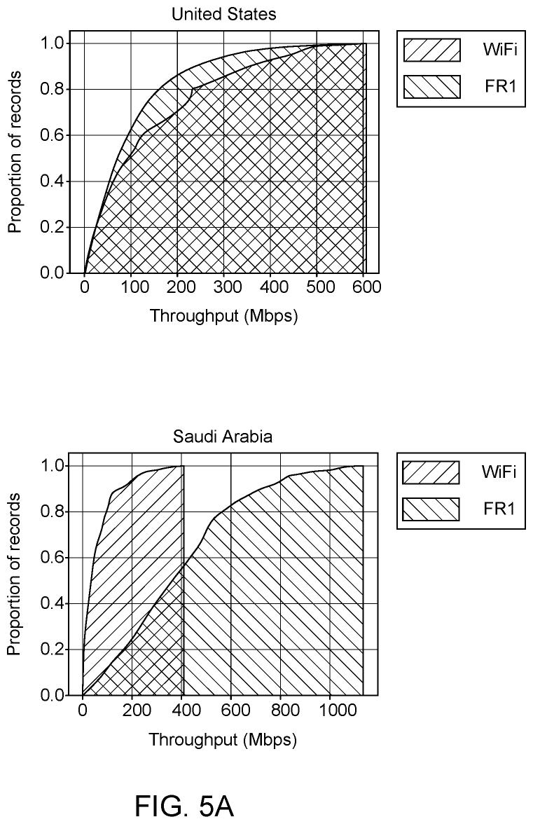

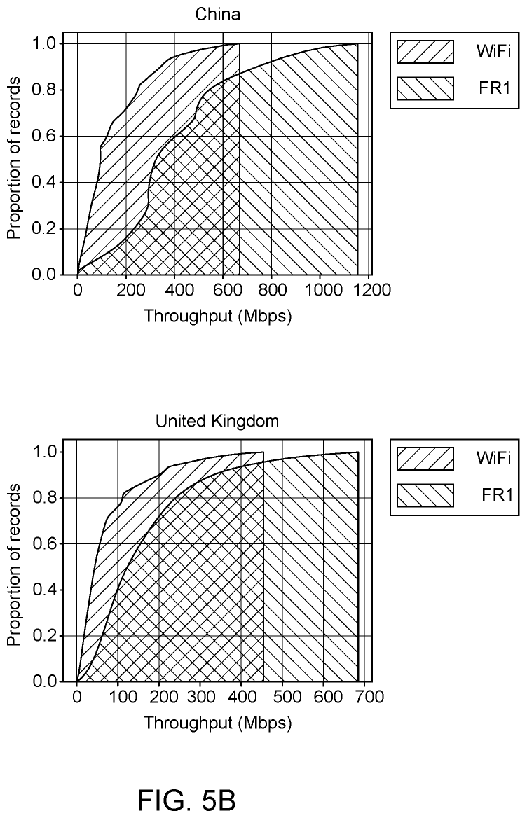

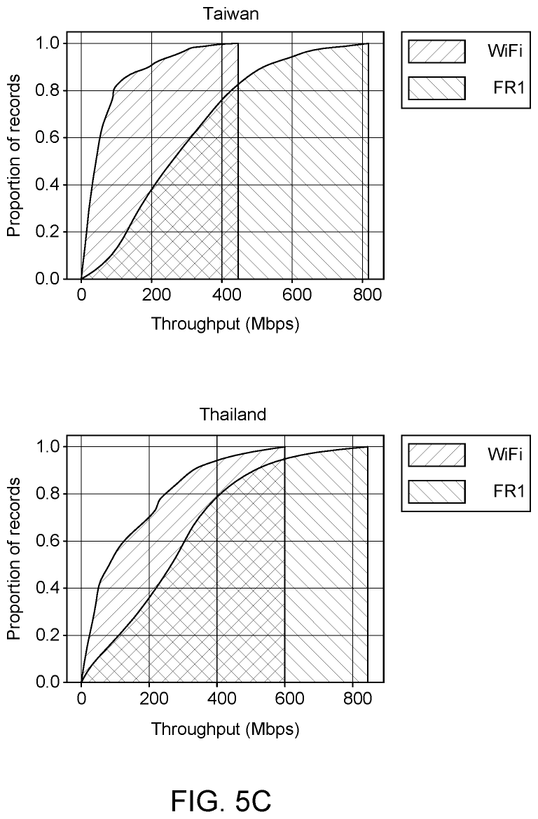

Combined characteristics on LTE+NR can be used to make a Wi-Fi vs. FR1 decision in 5G non-standalone (NSA) networks. A theoretical max throughput based on the RRC configuration can also be communicated by the modem to the operating system. In scenarios where observed Wi-Fi speed is greater than the theoretical max throughput on cellular, there will be no evaluation on cellular outrank regardless of the observed physical (PHY)/medium access control (MAC) characteristics. DL/UL observed throughput by the modem along with the LTE+NR connection characteristics will also be cached by WRM per serving cell ID, for future Wi-Fi vs. cellular decisions where no real time data about cellular while Wi-Fi is the primary interface is available. By using a combination of the real-time and cached LTE+NR characteristics described above, and as shown in FIGS. 5A, 5B, and 5C, WRM can derive the cellular score to make cellular outrank decisions based on pre-defined thresholds.

In scenarios where both real-time and cached data about cellular radio characteristics are not available or are insufficient for decision making, WRM will also query a crowd sourced database to learn about the common cellular characteristics and performance observed by customers while using that particular Wi-Fi AP/SSID or geolocation co-ordinate of device. WRM will recommend cell if available cellular radio has the ability to provide a better performance to the active application than the active Wi-Fi interface. WRM provides a cellular score along with confidence level to network system for decision making.

Cellular radio thresholds that are used to rank cellular over Wi-Fi can be adjusted based on a carrier/country basis, since the both Wi-Fi and cellular performance shows significant variance based on a country where the device is operating, and a carrier used by the device. For instance, using several specific examples, 50 Mhz LTE+NR FR1 aggregate bandwidth on NSA can be good enough to beat the average Wi-Fi quality in Saudi Arabia, but not in the U.S. Similarly, LTE+NR configured BW>=120, NR RSRP>−98.5 can be used to beat P90 throughput in 5 Ghz, whereas LTE+NR configured BW>=95, NR scheduled MIMO Layers>=3, NR RSRP>−93.5 is enough to beat P99 Wi-Fi 2.4 Ghz. WRM cellular link evaluation logic is aware of RRC state and considers different metrics in RRC idle or active state for decision making. The following logic describes WRM cellular link evaluation:

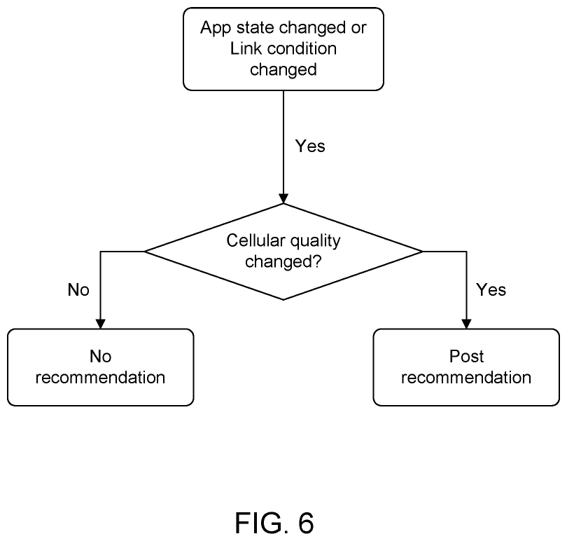

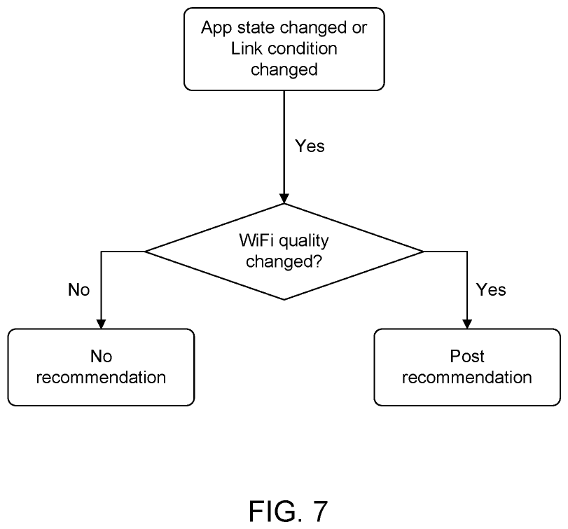

In addition to the cellular score, WRM provides Wi-Fi quality information (as shown in FIG. 6) and recommended links to the networking system. The Wi-Fi quality information consists up of Wi-Fi score and confidence level. WRM calculates Wi-Fi scores using radio, MAC, and application layer metrics. FIG. 7 illustrates WRM Wi-Fi link evaluation logic.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method of selecting a network interface for a communication device having at least two radio physical interfaces, the selecting to improve communications by the communication device, the method comprising:
determining, by a configuration daemon associated with an operating system of the communication device, a first radio physical interface as a primary interface and a second radio physical interface as idle, the primary interface being active;
executing, by a networking subsystem of the operating system, a state machine configured to monitor network conditions and associated performance parameters of the at least two radio physical interfaces, the state machine receiving input from one or more data-gathering subsystems associated with the operating system, the input characterizing the network conditions and the associated performance parameters;
providing, by the state machine in response to the monitored network conditions and associated performance parameters of the at least two radio physical interfaces, an outrank state indication to the configuration daemon, the outrank state indication indicating whether the second radio physical interface should be the primary interface; and
configuring, by the configuration daemon, the second radio physical interface as the primary interface and the first radio physical interface as idle.

2. The method in accordance with claim 1, wherein providing the outrank state indication further includes providing, by the state machine, an armed state indication before the outrank state indication when prerequisites of the monitored network conditions and performance parameters are met, the armed state indicating whether the second radio physical interface should be designated as the primary interface.

3. The method in accordance with claim 1, wherein configuring the second radio physical interface as the primary interface and the first radio physical interface as idle is performed automatically by the configuration daemon without user interaction.

4. The method in accordance with claim 1, wherein the first radio physical interface is a Wi-Fi interface, and wherein the second radio physical interface is a cellular interface.

5. The method in accordance with claim 4, wherein the one or more data-gathering subsystems associated with the operating system include one or more of a wireless radio coexistence subsystem, a cellular subsystem, a media subsystem, a device-driver subsystem, a device power/thermal subsystem, a network statistics subsystem, a networking services discovery daemon, a networking framework, a Wi-Fi subsystem, and a device thermal subsystem.

6. The method in accordance with claim 1, wherein the one or more data-gathering subsystems are configured to monitor application activity of the communication device.

7. The method in accordance with claim 1, wherein the performance parameters of the at least two radio physical interfaces include a comparative cost for operating each of the at least two radio physical interfaces.

8. A computer program product for selecting a network interface for a communication device having at least two radio physical interfaces, the selecting to improve communications by the communication device, the computer program product comprising a non-transitory machine-readable medium storing instructions that, when executed by at least one programmable processor, cause the at least one programmable processor to perform operations comprising:
determine a first radio physical interface as a primary interface and a second radio physical interface as idle, the primary interface being active;
execute a state machine configured to monitor network conditions and associated performance parameters of the at least two radio physical interfaces, the state machine receiving input from one or more data-gathering subsystems associated with an operating system of the communication device, the input characterizing the network conditions and the associated performance parameters;
provide, in response to the monitored network conditions and associated performance parameters of the at least two radio physical interfaces, an outrank state indication to the configuration daemon, the outrank state indication indicating whether the second radio physical interface should be the primary interface; and
configure the second radio physical interface as the primary interface and the first radio physical interface as idle.

9. The computer program product in accordance with claim 8, wherein the operation to provide the outrank state indication further includes providing, by the state machine, an armed state indication before the outrank state indication when prerequisites of the monitored network conditions and performance parameters are met, the armed state indicating whether the second radio physical interface should be designated as the primary interface.

10. The computer program product in accordance with claim 8, wherein the operation to configure the second radio physical interface as the primary interface and the first radio physical interface as idle is performed automatically by the configuration daemon without user interaction.

11. The computer program product in accordance with claim 8, wherein the first radio physical interface is a Wi-Fi interface, and wherein the second radio physical interface is a cellular interface.

12. The computer program product in accordance with claim 11, wherein the one or more data-gathering subsystems associated with the operating system include one or more of a wireless radio coexistence subsystem, a cellular subsystem, a media subsystem, a device-driver subsystem, a device power/thermal subsystem, a network statistics subsystem, a networking services discovery daemon, a networking framework, a Wi-Fi subsystem, and a device thermal subsystem.

13. The computer program product in accordance with claim 8, wherein the one or more data-gathering subsystems are configured to monitor application activity of the communication device.

14. The computer program product in accordance with claim 8, wherein the performance parameters of the at least two radio physical interfaces include a comparative cost for operating each of the at least two radio physical interfaces.

15. A system for selecting a network interface for a communication device having at least two radio physical interfaces, the selecting to improve communications by the communication device, the method comprising:
a configuration daemon associated with an operating system of the communication device, and being configured to determine a first radio physical interface as a primary interface and a second radio physical interface as idle, the primary interface being active; and
a networking subsystem of the operating system being configured to execute a state machine, the state machine being configured to monitor network conditions and associated performance parameters of the at least two radio physical interfaces, the state machine receiving input from one or more data-gathering subsystems associated with the operating system, the input characterizing the network conditions and the associated performance parameters, the state machine providing, in response to the monitored network conditions and associated performance parameters of the at least two radio physical interfaces, an outrank state indication to the configuration daemon, the outrank state indication indicating whether the second radio physical interface should be the primary interface; and
wherein the configuration daemon configures the second radio physical interface as the primary interface and the first radio physical interface as idle.

16. The system in accordance with claim 15, wherein providing the outrank state indication further includes providing, by the state machine, an armed state indication before the outrank state indication when prerequisites of the monitored network conditions and performance parameters are met, the armed state indicating whether the second radio physical interface should be designated as the primary interface.

17. The system in accordance with claim 15, wherein configuring the second radio physical interface as the primary interface and the first radio physical interface as idle is performed automatically by the configuration daemon without user interaction.

18. The system in accordance with claim 15, wherein the first radio physical interface is a Wi-Fi interface, and wherein the second radio physical interface is a cellular interface.

19. The system in accordance with claim 18, wherein the one or more data-gathering subsystems associated with the operating system include one or more of a wireless radio coexistence subsystem, a cellular subsystem, a media subsystem, a device-driver subsystem, a device power/thermal subsystem, a network statistics subsystem, a networking services discovery daemon, a networking framework, a Wi-Fi subsystem, and a device thermal subsystem.

20. (canceled)

21. The system in accordance with claim 15, wherein the performance parameters of the at least two radio physical interfaces include a comparative cost for operating each of the at least two radio physical interfaces.
